(19) United States
(12) Patent Application Publication
(10) Pub. No.: US 2012/0137107 A1
(43) Pub. Date: May 31, 2012

(54) METHOD OF DECAYING HOT DATA

(76) Inventor: Hung-Ming Lee, Hsinchu County (TW)

(21) Appl. No.: 13/291,068

(22) Filed: Nov. 7, 2011

(30) Foreign Application Priority Data
Nov. 26, 2010 (TW) 099140971

(51) Int. Cl. G06F 12/06

(52) U.S. Cl. 711/209; 711/E12.078

(57) ABSTRACT

Reserve a plurality of blocks in a flash. Write a plurality of hot data into the plurality of blocks in a cyclic and sequential manner. After completing a cycle of writing data and hot data is to be written into the plurality of blocks, send a logic block address corresponding to hot data of a page to a cold/hot data identifying engine if the hot data of the page of a decay block are not updated. And the cold/hot data identifying engine decays a count of a counter corresponding to the logic block address according to the logic block address.

### BACKGROUND OF THE INVENTION

1. Field of the Invention

The present invention is related to a method of decaying hot data, and particularly to a method that performs feedback based on hot data blocks to decay hot data.

2. Description of the Prior Art

The prior art determines whether a datum is a hot datum or a cold datum according to how many times an address corresponding to the datum is accessed within a period of time. Each address corresponds to a counter which counts number of times (count) the address is accessed within a period of time. Therefore, the prior art requires a large static random access memory (SRAM) to store the count of the address accessed, and because each address corresponds to a counter, the prior art spends much time handling all of the counters. The prior art decays counts of all counters each period of time (such as every 5000 data writing operations), and decays the counts of all counters again after a period of time. Therefore, if a datum is not accessed for a long time, count of a counter corresponding to the datum is decayed to lower than a threshold of hot data, resulting in the datum becoming a cold datum. In addition to requiring the large static random access memory and spending much time, the prior art may decay a new hot datum to a cold datum when count of a counter corresponding to the new hot datum is not large enough. In addition, the prior art can utilize a hash method. That is to say, one counter may correspond to multiple addresses to reduce the number of counters. However, a cold datum/hot datum may be misjudged because many addresses share one counter.

### SUMMARY OF THE INVENTION

An embodiment provides a method of decaying hot data. The method includes reserving a plurality of blocks in a flash, where each block includes a plurality of pages, and each page is used for storing a hot datum; writing a plurality of hot data into the plurality of blocks in a cyclic and sequential manner; sending a logic block address corresponding to a hot datum of a page of a decay block to a cold/hot data identifying engine when the hot datum of the page are not updated after completing a cycle of writing data and writing hot data into the plurality of blocks again; the cold/hot data identifying engine decaying a count of a counter corresponding to the logic block address according to the logic block address.

The present invention provides a method of decaying hot data. The method includes reserving first a hot data block ring in a flash, writing a plurality of hot data into the hot data block ring in a cyclic and sequential manner, sending a logic block address corresponding to a hot datum of a page of a decay block to a cold/hot data identifying engine when the hot datum of the page is not updated after completing a cycle of writing data and writing hot data into the hot data block ring again, and the cold/hot data identifying engine decaying a count counted by a counter corresponding to the logic block address according to the logic block address. Thus, the present invention not only improves a disadvantage of all counters are decayed simultaneously, but also does not spend much time handling all the counters.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a hot data area for decaying hot data.

FIG. 2 is a flowchart illustrating a method of decaying hot data according to an embodiment.

### DETAILED DESCRIPTION

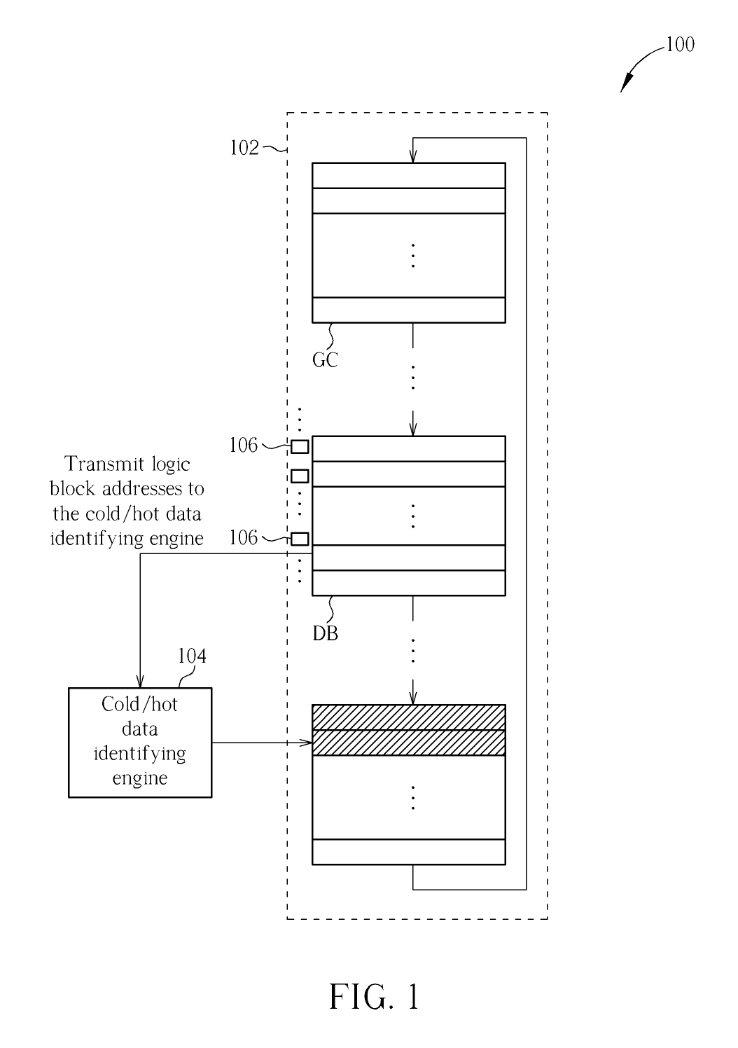

Please refer to FIG. 1. FIG. 1 is a diagram illustrating a hot data area 100 for decaying hot data. The hot data area 100 includes a hot data block ring 102, a cold/hot data identifying engine 104, and a plurality of counters 106. The hot data block ring 102 is a plurality of blocks in a flash, where each block includes a plurality of pages, and each page is used for storing a hot datum. Hot data are written into the hot data block ring 102 in a cyclic and sequential manner. The cold/hot data identifying engine 104 is used for decaying count counted by the counter 106 corresponding to a logic block address according to the logic block address.

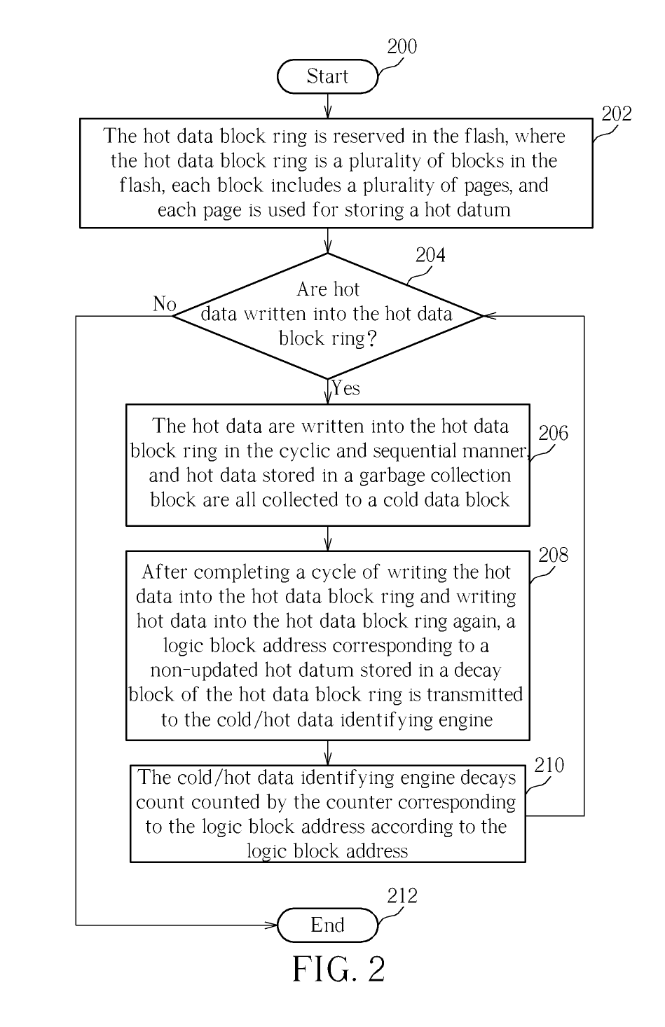

Please refer to FIG. 2. FIG. 2 is a flowchart illustrating a method of decaying hot data according to an embodiment. The method in FIG. 2 uses the hot data area 100 in FIG. 1 to illustrate the method. Detailed steps are as follows:

Step 200: Start.

Step 202: The hot data block ring 102 is reserved in the flash, where the hot data block ring 102 is a plurality of blocks in the flash, each block includes a plurality of pages, and each page is used for storing a hot datum.

Step 204: Are hot data written into the hot data block ring 102? If yes, go to Step 206; if no, go to Step 212.

Step 206: The hot data are written into the hot data block ring 102 in the cyclic and sequential manner, and hot data stored in a garbage collection block GC are all collected to a cold data block.

Step 208: After completing a cycle of writing the hot data into the hot data block ring 102 and writing hot data into the hot data block ring 102 again, a logic block address (LBA) corresponding to a non-updated hot datum stored in a decay block DB of the hot data block ring 102 is transmitted to the cold/hot data identifying engine 104.

Step 210: The cold/hot data identifying engine 104 decays count counted by the counter 106 corresponding to the logic block address according to the logic block address; go to Step 204.

Step 212: End.

In Step 204, if no hot data are written into the hot data block ring 102, go to Step 212. Meanwhile, the hot data stored in the garbage collection block GC are stopped from being collected into the cold data block. In Step 206, for empty space in the flash, all hot data stored in the garbage collection block GC are collected to the cold data block, where the garbage collection block GC is a block next to a block (active block) to which hot data is to be written. But, the present invention is not limited to the garbage collection block GC being the block next to the block to which hot data is to be written. In another embodiment of the present invention, the garbage collection block GC is any block other than a block next to the active block. In Step 208, after completing a cycle of writing the hot data into the hot data block ring 102 and starting to write hot data into a first block of the hot data block ring 102 again, a hot datum stored in a page of the decay block DB of the hot data block ring 102 is determined to be not hot enough if the hot datum stored in the page is not updated. Because the hot datum stored in the page is not hot enough, the logic block address corresponding to the hot datum is transmitted to the cold/hot data identifying engine 104, where a physical page number of the page is different from a logic block address corresponding to the hot datum stored in the page. In Step 210, the cold/hot data identifying engine 104 decays the count counted by the counter 106 corresponding to the logic block address according to the logic block address for responding to the not hot enough condition of the hot datum stored in the page, where the cold/hot data identifying engine 104 divides the count corresponding to the logic block address by a predetermined number and/or decreases the count to zero to decay the count corresponding to the logic block address. In addition, the garbage collection block GC is the same as the decay block DB. But, in another embodiment of the present invention, the garbage collection block GC is different from the decay block DB.

To sum up, the method of decaying the hot data includes reserving first the hot data block ring in the flash, writing the plurality of hot data into the hot data block ring in the cyclic and sequential manner, sending the logic block address corresponding to the hot datum of the page of the decay block to the cold/hot data identifying engine when the hot datum of the page is not updated after completing a cycle of writing data and writing hot data into the hot data block ring again, and the cold/hot data identifying engine decaying the count counted by the counter corresponding to the logic block address according to the logic block address. Thus, the present invention not only improves a disadvantage of all counters being decayed simultaneously, but also does not spend much time handling all the counters.

Those skilled in the art will readily observe that numerous modifications and alterations of the device and method may be made while retaining the teachings of the invention.

What is claimed is:

1. A method of decaying hot data, the method comprising:
reserving a plurality of blocks in a flash, wherein each block includes a plurality of pages, and each page is used for storing a hot datum;
writing a plurality of hot data into the plurality of blocks in a cyclic and sequential manner;
sending a logic block address corresponding to a hot datum of a page of a decay block to a cold/hot data identifying engine when the hot datum of the page are not updated after completing a cycle of writing data and writing hot data into the plurality of blocks again; and
the cold/hot data identifying engine decaying a count of a counter corresponding to the logic block address according to the logic block address.

2. The method of claim 1, wherein decaying the count of the counter corresponding to the logic block address is dividing the count by a predetermined number.

3. The method of claim 1, wherein the step of decaying the count of the counter corresponding to the logic block address comprises decreasing the count to zero.

4. The method of claim 1, wherein a physical page number of each page is different from the logic block address corresponding to the hot datum stored in the page.

5. The method of claim 1, the method further comprising:
collecting all hot data stored in a garbage collection block to a cold data block.

6. The method of claim 5, wherein the garbage collection block is the same as the decay block.

7. The method of claim 5, wherein the garbage collection block is different from the decay block.

8. The method of claim 5, wherein a block to which hot data is to be written is an active block, and the garbage collection block is a block next to the active block.

9. The method of claim 5, wherein a block to which hot data is to be written is an active block, and the garbage collection block is any block other than a block next to the active block.

10. The method of claim 5, the method further comprising:
stopping to collect the hot data stored in a garbage collection block to the cold data block when hot data are not written into the plurality of blocks.
